(19) United States
(12) Patent Application Publication
(10) Pub. No.: US 2010/0172815 A1
(43) Pub. Date: Jul. 8, 2010

(54) Method of Manufacturing Superhydrophobic Silica-Based Powder

(75) Inventors: Ho Sung Park, Dongnae-gu (KR); Sharad D. Bhagat, Maharashtra State (IN); Jong-Hyun Lim, Gyeonggi-do (KR); Young-Chul Joung, Gyeonggi-do (KR); Jong-Chul Park, Chungcheongnam-do (KR); Seung-Yong Jee, Chungcheongnam-do (KR)

Correspondence Address: FLASTER/GREENBERG P.C.;Four Penn Center, 1600 John F. Kennedy Boulevard, 2nd Floor, PHILADELPHIA, PA, 19103, US

(73) Assignee: EM-Power Co., Ltd., Unbong-Myeon, Asan-si, Chungcheongnam-do (KR)

(21) Appl. No.: 12/601,523

(22) PCT Filed: Dec. 4, 2007
(86) PCT No.: PCT/KR07/06234

§ 371 Date: Nov. 23, 2009

(30) Foreign Application Priority Data
May 23, 2007 (KR) 10-2007-0050213

(51) Int. Cl. C01B 33/141

(52) U.S. Cl. 423/338

(57) ABSTRACT

Disclosed is a method of manufacturing superhydrophobic silica-based powder, including adding a water glass solution, which is not subjected to ion exchange, serving as a precursor, with an organosilane compound having an alkaline pH and an inorganic acid to thus subject the water glass solution to surface modification and gelation, thereby producing hydrogel, immersing the hydrogel in a nonpolar solvent to thus subject the hydrogel to solvent exchange and Na⁺ removal, and drying the hydrogel, subjected to solvent exchange, at ambient pressure, thereby manufacturing aerogel powder. This invention is very important from an industrial point of view because it involves a very simple process and realizes economic benefits.

### BACKGROUND OF THE INVENTION

1. Field of the Invention

The present invention relates to a method of manufacturing superhydrophobic silica-based powder, and more particularly, to a method of simply and economically manufacturing superhydrophobic silica-based (silica aerogel) powder through ambient pressure drying using a water glass solution, which is not subjected to ion exchange.

2. Description of Related Art

Silica aerogel powder is the lightest known existing solid. This is because silica aerogel powder has a nanoporous structure having a high porosity of at least 90% and a high specific surface area of at least 600 m²/g. Further, the silica aerogel powder may be usefully applied to many scientific and industrial fields, including heat insulators, catalyst supports and dielectric materials. However, the use thereof in such a broad range of application fields is extremely limited to date. This is considered to be attributable to the requirement that a supercritical fluid extraction technique be used to dry the gel, undesirably incurring high costs and hazards.

Meanwhile, ambient pressure drying (APD) involves chemical surface modification (which is essential to maintain the high porosity of the gel during APD) of hydrogel using an organosilane reagent, and thus is regarded as a safe and economical aerogel production method. However, the APD may generate particles having a dense structure, called xerogel, attributable to stress and capillary force in the course of drying. Hence, some attempts to develop methods of allowing the aerogel powder to endure capillary force through grafting using nonpolar groups during APD have been made. However, APD is problematic in that a high cost is incurred and a long time is required.

Silica aerogel products may be produced using a water glass solution as a precursor. In this case, the Na⁺ of the water glass should be removed through an ion exchange resin reaction. Thus, when it is intended to conduct mass production using the above process, the treatment procedure becomes complicated and the investment cost is increased. Further more, because conventional surface modification and solvent exchange should be performed for a long period of time using expensive chemical material, problems in which the manufacturing process is prolonged and the production cost is increased are undesirably caused.

### BRIEF SUMMARY OF THE INVENTION

Accordingly, the present invention has been devised keeping in mind the above problems occurring in the related art, and provides a method of simply and economically manufacturing superhydrophobic silica-based (silica aerogel) powder using an inexpensive precursor, such as a water glass solution, by means of a wet gel drying process, such as APD.

The present invention is characterized in that ion exchange for removing Na⁺ from a water glass solution, serving as a precursor, is omitted. Specifically, the method of the present invention allows Na⁺ to be eliminated along with water in the course of solvent displacement, thereby simplifying the process and generating economic benefits.

In the present invention, conventional problems such as the time-consuming surface modification and solvent exchange in the synthesis of aerogel from water glass via APD may be overcome by reducing the total treatment time of aerogel powder to 5 hours by means of a co-precursor method using HNO₃/hexamethyldisilazane (HMDS) for the rapid surface modification of hydrogel. The method of manufacturing the aerogel powder is very important from the points of view of mass production and commercial availability thereof.

According to the present invention, there is provided a method of manufacturing superhydrophobic silica-based powder, adding a water glass solution, which is not subjected to ion exchange, serving as a precursor, with an organosilane compound having an alkaline pH and an inorganic acid to thus subject the water glass solution to surface modification and gelation, thereby producing hydrogel, immersing the hydrogel in a nonpolar solvent to thus subject the hydrogel to solvent exchange and Na⁺ removal, and drying the hydrogel, subjected to solvent exchange, at ambient pressure, thereby manufacturing aerogel powder.

The water glass solution may be an inorganic precursor of silica (29 wt %), and may be used with a silica content in the range of 1˜10 wt % by diluting the precursor with deionized water. The organosilane compound may be hexamethyldisilazane (HMDS), and the inorganic acid may be acetic acid or hydrochloric acid.

In the method of the present invention, the water glass solution may be added with the organosilane compound to thus subject it to surface modification by a co-precursor method, and the hydrogel obtained by the co-precursor method may be immersed in the nonpolar solvent to thus subject it to solvent exchange and Na⁺ removal. The solvent exchange and Na⁺ removal may be conducted at a temperature ranging from room temperature to lower than 60° C. for up to 10 hours, and, as the nonpolar solvent, hexane or heptane may be used.

The drying of wet gel may be conducted at an ambient pressure of 1 atm at a temperature ranging from room temperature to 300° C. Further, the nonpolar solvent may be recovered through vapor condensation at the time of drying.

The method of the present invention may further include washing the hydrogel with water, or alternatively applying a vacuum to the hydrogel to thus remove water from the hydrogel, between immersing the hydrogel and drying the hydrogel. In addition, the method of the present invention may further include washing the hydrogel with water and then applying a vacuum to the hydrogel to thus remove water from the hydrogel, between immersing the hydrogel and drying the hydrogel.

According to the present invention, the method of manufacturing silica-based powder involves a very simple process and generates economic benefits. Thus, this invention is considered significant from an industrial point of view.

### BRIEF DESCRIPTION OF THE SEVERAL VIEWS OF THE DRAWING(S)

FIG. 1 is a flowchart illustrating the process of manufacturing superhydrophobic silica-based powder, according to the present invention;

FIG. 2 is a graph illustrating the results of FTIR of the silica aerogel powder according to the present invention;

FIG. 3 is a graph illustrating the results of EDAX of the silica aerogel powder according to the present invention; and

FIG. 4 is an image of FE-SEM of the silica aerogel powder according to the present invention.

### DETAILED DESCRIPTION OF THE INVENTION

Hereinafter, a detailed description will be given of a method of manufacturing superhydrophobic silica-based powder according to a preferred embodiment of the present invention, with reference to the appended drawings.

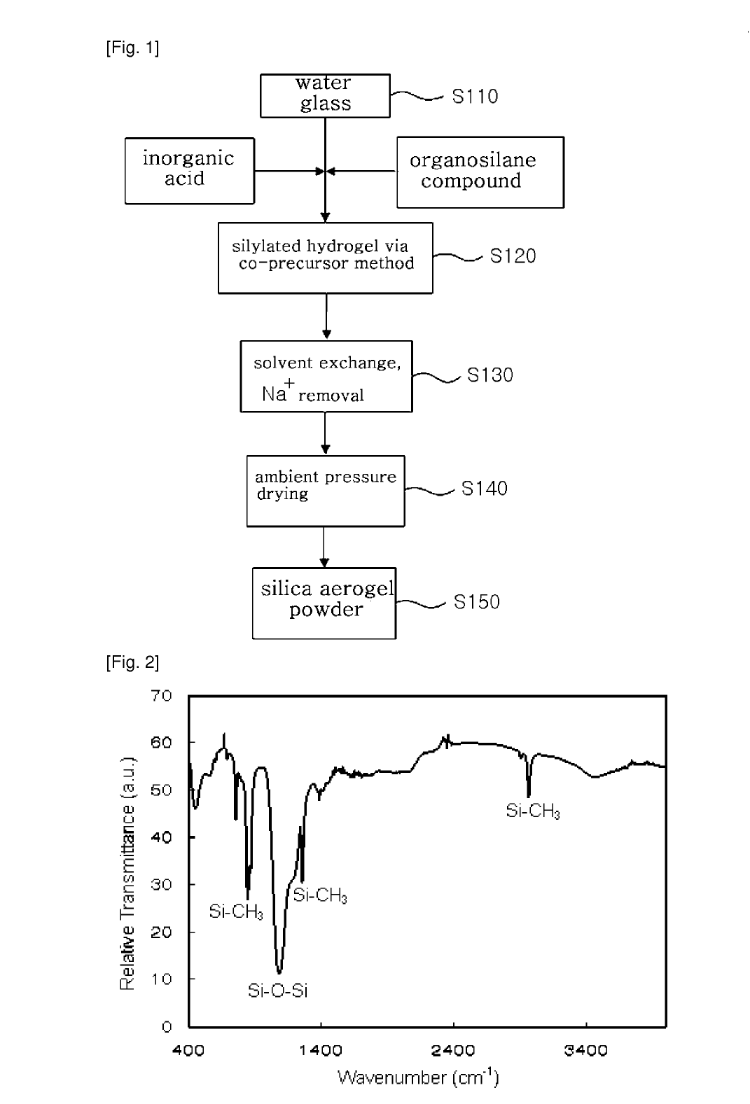

FIG. 1 is a flowchart illustrating the process of manufacturing superhydrophobic silica-based (silica aerogel) powder according to the present invention. As illustrated in FIG. 1, in the present invention, Na⁺ is not removed through ion exchange, which is conducted before the production of silylated hydrogel, but Na⁺ is removed at the same time that water is removed from the silylated hydrogel via solvent exchange.

Specifically, in the present invention, a water glass solution, which is not subjected to ion exchange, is subjected to a co-precursor method with the addition of an inorganic acid (acetic acid or hydrochloric acid) and an organosilane compound, thus producing the silylated hydrogel (S110, S120). The organosilane compound, having an alkaline pH, is responsible for surface modification and gelation. In the present invention, the water glass solution is an inorganic precursor of silica (29 wt %), and may be used with a silica content in the range of 1˜10 wt % by diluting the precursor with deionized water. When the silica content is less than 1 wt % or exceeds 10 wt %, it is difficult to realize gelation. Preferably, the water glass solution is used with a silica content in the range of 3.5˜5 wt %.

As is apparent from the results of surface modification by the organosilane compound, pore water is drained out of the hydrogel, and, in order to produce the silica aerogel powder, according to the present invention, the hydrogel is immersed in an n-hexane solution or a heptane solution, which is a nonpolar solvent immiscible with water. Then, water is drained out of the network of the gel and hexane infiltrates the pores, thereby completing solvent exchange and Na⁺ removal through a single process (S130).

The solvent exchange and Na⁺ removal are conducted at a temperature ranging from room temperature to lower than 60° C. for up to 10 hours. The solvent exchange and Na⁺ removal correspond to the displacement of water in the network of the gel by hexane, and are possible under conditions of room temperature or higher. Specifically, when the temperature is lower than room temperature, the solvent exchange and Na+ removal take 10 hours or longer. On the other hand, when the temperature is equal to or higher than 60° C., the solvent displacement is not easy due to the volatility of hexane. In consideration of the properties of hexane, which is highly volatile, it is preferred that the above process be carried out at 40° C. for up to 3 hours. Hence, the major characteristic of the present invention is that ion exchange for the water glass solution as a precursor is omitted in the process of manufacturing the silica aerogel powder. The gel, obtained after the water displacement and solvent exchange, floats on the surface of the drained water.

In the present invention, after the solvent exchange and Na⁺ removal, washing of the gel with water may be further conducted, thereby completely removing the Na⁺ that is partially present in the gel.

In addition, after the solvent exchange and Na⁺ removal, a vacuum is applied to the gel to thus remove water from the gel, or alternatively, the gel is washed with water and then a vacuum is applied thereto to thus remove water from the gel. That is, a vacuum is applied to thus remove water before a subsequent drying process is conducted, thereby facilitating the drying process and additionally removing part of the hexane.

The water drainage and wet gel drying are performed at ambient pressure without aging. The wet gel may be dried at a temperature ranging from room temperature to 300° C., corresponding to the condition for volatilizing hexane present in the gel. When the drying of the wet gel is conducted at a temperature lower than room temperature, a long time of at least 2 days is required. On the other hand, when the drying of the wet gel is conducted at a temperature exceeding 300° C., the structure of the gel may break down. Preferably, the wet gel is dried in a furnace through a two-step process, including primary drying for 20 min at 170° C. and secondary drying for 10 min at 200° C., thus obtaining the silica aerogel powder (S140, S150). Therefore, in the present invention, the wet gel may be dried at an ambient pressure of 1 atm and at a temperature of 170˜200° C. Further, recovering the nonpolar solvent through vapor condensation in the course of drying the wet gel may be carried out.

The aerogel powder thus produced has a very low density and superior heat insulating properties. In addition, the aerogel powder has superhydrophobic properties, and such properties are maintained up to a temperature of 450° C., above which the powder becomes hydrophilic. Therefore, the method of manufacturing the aerogel powder according to the present invention is very important from a commercial point of view because it has a simple and economic process, making it suitable for mass production.

### Example

50 ml of a 4.35 wt % water glass solution, which was not subjected to ion exchange, was added with 5.8 ml of hexamethyldisilazane and 4.4 ml of acetic acid under predetermined stirring conditions, thus obtaining hydrogel. Then, the hydrogel thus obtained was allowed to stand in an n-hexane solution (60 ml) for about 3 hours to subject it to solvent exchange. After the solvent exchange, the hydrogel was removed from the beaker and was then dried at ambient pressure. The drying process was conducted for 20 min at 170° C. and then for 10 min at 200° C. The resulting silica aerogel powder had a low tapping density (0.12 g/cm³) and was superhydrophobic.

In order to confirm the surface modification of the hydrogel by a co-precursor method with respect to the silica aerogel powder manufactured through the above process, FTIR (Fourier Transform Infrared Spectroscopy) was carried out. FIG. 2 is a graph illustrating the results of FTIR of the silica aerogel powder, according to the present invention. As illustrated in FIG. 2, Si—CH³ peaks can be seen to be present, from which the surface modification by the co-precursor method can be confirmed to be realized.

Below, the properties of the silica aerogel powder, manufactured according to the present invention, are evaluated.

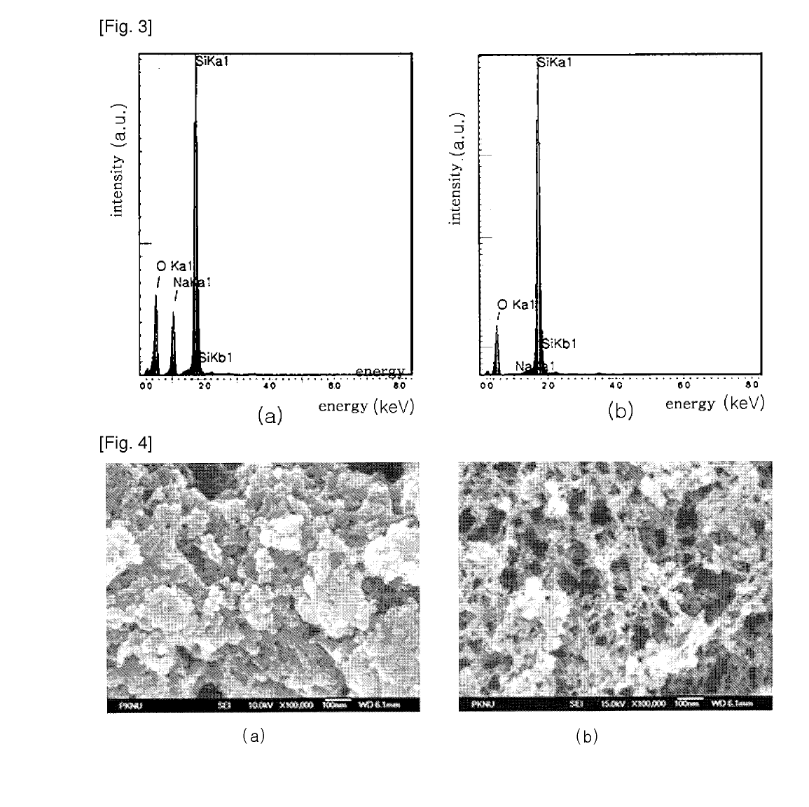

Using the silica aerogel powder, the Na⁺ concentration of the dried aerogel powder via water displacement was confirmed. FIG. 3 is a graph illustrating the results of EDAX (Energy Dispersive X-ray Analysis) of the silica aerogel powder, in which (a) shows the case where water displacement is not conducted and (b) shows the case where water displacement is conducted.

Further, through the tapping density of the silica aerogel powder and the structural analysis thereof, the properties of the aerogel were confirmed. The data results of the tapping density and structural analysis of the silica aerogel powder, depending on the composition thereof, are summarized in Table 1 below.

TABLE 1

| | Added | Added | Drained | Tapping | Surface |
|---|---|---|---|---|---|
| Added 4.35 wt % | HNO₃ | HMDS | Pore | Density | Area |
| Water Glass (ml) | (ml) | (ml) | Water (ml) | (g/cm³) | (m²/g) |
| 50 | 2.4 | 4 | 30 | 0.64 | 173 |
| 50 | 2.6 | 4 | 36 | 0.54 | 185 |
| 50 | 3.5 | 4 | 40 | 0.31 | 695 |
| 50 | 3.7 | 4 | 45 | 0.28 | 732 |
| 50 | 4.3 | 5.8 | 45 | 0.17 | 712 |
| 50 | 4.3 | 5.8 | 46 | 0.19 | 738 |
| 50 | 4.3 | 6.0 | 47 | 0.16 | 778 |
| 50 | 4.3 | 6.2 | 47 | 0.18 | 690 |
| 50 | 4.4 | 5.8 | 50 | 0.12 | — |

Further, the silica aerogel powder according to the present invention was subjected to FE-SEM (Field-Emission Scanning Electron Microscopy), and thus the nanoporous structure of the aerogel was confirmed. FIG. 4 illustrates an image of FE-SEM of the silica aerogel powder according to the present invention, in which (a) shows the aerogel powder which is not subjected to water displacement, and (b) shows the aerogel powder which is subjected to water displacement. As seen in FIG. 4, the aerogel powder, in which water displacement is not conducted, can be seen to have a dense structure, whereas the aerogel powder, in which water displacement is conducted, can be seen to have a nanoporous structure. This phenomenon is attributed to the unique properties of the aerogel.

As described hereinbefore, the preferred embodiment of the present invention in regard to the method of manufacturing superhydrophobic silica-based powder with reference to the appended drawings is set forth to illustrate, but is not to be construed as the limit of, the present invention.

Further, those skilled in the art will appreciate that various modifications, additions and substitutions are possible without departing from the scope and technical spirit of the invention as disclosed in the accompanying claims.

### INDUSTRIAL APPLICABILITY

The present invention may be variously applied to the energy field, environmental field, electrical/electronic field, and other fields. Specifically, the silica-based powder according to the present invention may be used in the energy field, including transparent/semi-transparent insulators, polyurethane substitutes, interior/exterior construction materials, etc., the environmental field, including gas/liquid separating filters, VOC/NOₓ removing catalyst systems, etc., the electrical/electronic field, including interlayer insulating films for semiconductors, microwave circuit materials, etc., and other fields, including sound-absorbing paint, sound-absorbing panels, other sound-absorbing materials, and luminescent materials.

We claim:

1. A method of manufacturing superhydrophobic silica-based powder, comprising:
adding a water glass solution, which is not subjected to ion exchange, serving as a precursor, with an organosilane compound having an alkaline pH and an inorganic acid to thus subject the water glass solution to surface modification and gelation, thereby producing a hydrogel;
immersing the hydrogel in a nonpolar solvent to thus subject the hydrogel to solvent exchange and Na+ removal; and
drying the hydrogel, subjected to solvent exchange, at an ambient pressure, thereby manufacturing an aerogel powder.

2. The method according to claim 1, wherein the water glass solution is an inorganic precursor of silica (29 wt %), and is used with a silica content in a range of 1˜10 wt % by diluting the precursor with deionized water.

3. The method according to claim 1, wherein the organosilane compound is hexamethyldisilazane (HMDS).

4. The method according to claim 1, wherein the inorganic acid is acetic acid or hydrochloric acid.

5. The method according to claim 1, wherein the water glass solution is added with the organosilane compound to thus subject it to surface modification by a co-precursor method.

6. The method according to claim 5, wherein the hydrogel, obtained by the co-precursor method, is immersed in the nonpolar solvent to thus subject it to solvent exchange and Na⁺ removal.

7. The method according to claim 1, wherein the solvent exchange and Na⁺ removal are conducted at a temperature ranging from room temperature to lower than 60° C. for up to 10 hours.

8. The method according to claim 1, wherein the nonpolar solvent is hexane or heptane.

9. The method according to claim 1, wherein the drying is conducted at an ambient pressure of 1 atm and at a temperature ranging from room temperature to 300° C.

10. The method according to claim 1, wherein the nonpolar solvent is recovered through vapor condensation during the drying.

11. The method according to claim 1, further comprising washing the hydrogel with water, between immersing the hydrogel and drying the hydrogel.

12. The method according to claim 1, further comprising applying a vacuum to the hydrogel to thus remove water from the hydrogel, between immersing the hydrogel and drying the hydrogel.

13. The method according to claim 1, further comprising washing the hydrogel with water and then applying a vacuum to the hydrogel to thus remove water from the hydrogel, between immersing the hydrogel and drying the hydrogel.
